(19) United States
(12) Patent Application Publication
(10) Pub. No.: US 2007/0282047 A1
(43) Pub. Date: Dec. 6, 2007

(54) Room temperature-curable organopolysiloxane composition

(75) Inventors: Tsuneo Kimura, Annaka-shi (JP); Masaya Ueno, Annaka-shi (JP); Norio Kameda, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/806,768

(22) Filed: Jun. 4, 2007

(30) Foreign Application Priority Data
Jun. 5, 2006 (JP) 2006-155821

(51) Int. Cl. B60C 1/00

(52) U.S. Cl. 524/261; 524/588

(57) ABSTRACT

A room temperature-curable polyorganosiloxane composition is provided. The composition comprises

(A) 100 parts by weight of a polyorganosiloxane represented by the following general formula (1):

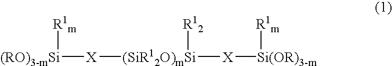

wherein R is a monovalent hydrocarbon group containing 1 to 5 carbon atoms, R¹ is independently a substituted or unsubstituted monovalent hydrocarbon group containing 1 to 10 carbon atoms; n is an integer of at least 10; X is oxygen atom or an alkylene group containing 2 to 5 carbon atoms, and m is independently an integer of 0 or 1; or a mixture of such polyorganosiloxane,

(B) 0.1 to 50 parts by weight of a partial hydrolysate of an organosilicon compound having at least 3 hydrolyzable groups bonded to silicon atom in one molecule;

(C) 1 to 500 parts by weight of at least one filler,

(D) 0.01 to 10 parts by weight of a curing catalyst, and

(E) 0.1 to 10 parts by weight of a silane coupling agent.

The present invention is capable of forming a rubber elastomer which exhibits excellent adhesion to resins whose adhesion has been difficult, for example, polyimide resin.

### CROSS-REFERENCE TO RELATED APPLICATION

This non-provisional application claims priority under 35 U.S.C. §119(a) on Patent Application No. 2006-155821 filed in Japan on Jun. 5, 2006, the entire contents of which are hereby incorporated by reference.

### TECHNICAL FIELD

This invention relates to a room temperature-curable polyorganosiloxane composition which cures by reacting with moisture in the air to form a rubber elastomer, and more specifically, to a room temperature-curable polyorganosiloxane composition which is capable of providing a rubber elastomer which exhibits good adhesion to resin substrates whose adhesion has been difficult.

### BACKGROUND ART

Various types of room temperature-curable polyorganosiloxane compositions which cure at room temperature to form an elastomer by contacting with moisture in air have been known in the art. Among these, room temperature-curable polyorganosiloxane compositions of alcohol-releasing type which cure by releasing the alcohol have been the favorite choice for sealing electric and electronic parts as well as for use in adhesive and coating applications since the compositions of this type are free from unpleasant odors and does not corrode metals.

Typical example of such polyorganosiloxane composition is the one disclosed in JP-B 39-27643 (Patent Document 1) which is a composition comprising a polyorganosiloxane endcapped with hydroxy group, an alkoxysilane, and an organotitanium compound. JP-A 55-43119 (Patent Document 2) discloses a composition comprising a polyorganosiloxane endcapped with an alkoxy silyl group, an alkoxysilane, and an alkoxy titanium. JP-B 7-39547 (Patent Document 3) discloses a composition comprising a polyorganosiloxane endcapped with an alkoxy silyl group containing silethylene group, an alkoxysilane, and an alkoxy titanium. With regard to such compositions of alcohol-releasing type, various improvements including the improvements in production method and storage stability (prevention of change with lapse of time) have been attempted, and despite the similar composition used in such attempts, the particular formulation used has significant meaning in order to satisfy the requirements posed on the products and realize the intended properties.

In the meanwhile, resins used in casing and other parts of electric and electronic products have experienced improvement in their durability, and in the case of such resins with improved durability, adhesion of the resin with conventional sealant is often difficult, and the compositions as described above which have been used for sealing, bonding, and coating electric and electronic products failed to exhibit sufficient adhesion to such resins.

### DISCLOSURE OF THE INVENTION

The present invention has been achieved in view of the situation as described above, and an object of the present invention is to provide a room temperature-curable polyorganosiloxane composition which is adapted for use as a sealant, or as a cured product exhibiting excellent adhesion to resins whose adhesion has been difficult, which can be used for adhesion and securing of electric and electronic parts.

In order to achieve such object, the inventors of the present invention made an intensive study and found that a polyorganosiloxane composition which is capable of providing a rubber elastomer having an excellent storage stability as well as a remarkably improved adhesion to resins whose adhesion has been difficult can be realized by using a polyorganosiloxane having an alkoxysilyl group on both ends for the base polymer, and blending a curing agent, a filler, a titanium chelate catalyst, and a silane coupling agent with such polymer, and using a particular amount of a partial hydrolyzate/condensate of an alkoxysilane for the curing agent. The present invention has been completed on the bases of such finding.

Accordingly, the present invention provides a room temperature-curable polyorganosiloxane composition comprising

(A) 100 parts by weight of a polyorganosiloxane represented by the following general formula (1):

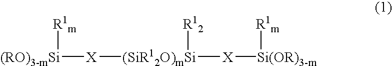

wherein R is a monovalent hydrocarbon group containing 1 to 5 carbon atoms, R¹ is independently a substituted or unsubstituted monovalent hydrocarbon group containing 1 to 10 carbon atoms; n is an integer of at least 10; X is oxygen atom or an alkylene group containing 2 to 5 carbon atoms, and m is independently an integer of 0 or 1; or a mixture of such polyorganosiloxane,

(B) 0.1 to 50 parts by weight of a partial hydrolysate of an organosilicon compound having at least 3 hydrolyzable groups bonded to silicon atom in one molecule;

(C) 1 to 500 parts by weight of at least one filler,

(D) 0.01 to 10 parts by weight of a curing catalyst, and

(E) 0.1 to 10 parts by weight of a silane coupling agent.

### EFFECTS OF THE INVENTION

The present invention is capable of forming a rubber elastomer which exhibits excellent adhesion to resins whose adhesion has been difficult, for example, polyimide resin.

In addition, since the composition of the present invention uses a partial hydrolysate of silane which has a boiling point higher than that of the silane monomer for the crosslinking agent, kneading of the composition can be conducted with high safety, and the composition can be kneaded with reduced volatilization of the crossliking agent component. Furthermore, the resulting composition has reduced odor with reduced content of the volatile component.

### DESCRIPTION OF THE PREFERRED EMBODIMENTS

### Component (A)

In the general formula (1) representing the polyorganosiloxane which is the component (A) in the present invention, R is a monovalent hydrocarbon group containing 1 to 5 carbon atoms, for example, an alkyl group such as methyl group, ethyl group, n-propyl group, isopropyl group, butyl group, or pentyl group. The plurality of R in the formula may be either the same or different, and R is preferably methyl group or ethyl group in view of reactivity in the hydrolysis. R¹ is independently a substituted or unsubstituted monovalent hydrocarbon group containing 1 to 10 carbon atoms, for example, an alkyl group such as methyl group, ethyl group, or propyl group; a cycloalkyl group such as cyclohexyl group; an alkenyl group such as vinyl group and allyl group; an aryl group such as phenyl group and tolyl group; or any of such groups having the hydrogen atoms partially substituted with a halogen atom, for example, 3,3,3-trifluoropropyl group. The plurality of R¹ in the formula may be either the same or different. n is an integer of at least 10, and in particular, an interger of the value which realizes the viscosity at 25° C. of the dipolydiorganosiloxane in the range of 25 to 500,000 mPa·s, and preferably in the range of 500 to 100,000 mPa·s. X is oxygen atom or an alkylene group containing 2 to 5 carbon atoms, for example, ethylene group, propylene group, or butylene group. m is independently an integer of 0 or 1. The viscosity is the value measured with a rotational viscometer.

### Component (B)

The component (B) is a partial hydrolysate of an organosilicon compound having at least 3 hydrolyzable groups bonded to silicon atom in one molecule. This component can be readily obtained by partially hydrolyzing the corresponding hydrolyzable silane compound. Exemplary hydrolyzable groups include ketoxime group, alkoxy group, acetoxy group, and isopropenoxy group, and the preferred is alkoxy group as in the case of the end group of the component (A). Exemplary hydrolyzable silane compounds include alkoxysilanes such as methyltrimethoxysilane, vinyltrimethoxysilane, phenyltrimethoxysilane, and vinyltriethoxy silane. The component (B) is a partial hydrolysate produced by hydrolyzing such an alkoxysilane, and the preferred is dimer to 30-mer, the more preferred are 3-mer to 20-mer, and the most preferred are tetramer to 10-mer of the corresponding alkoxysilane monomer. When alkoxysilane monomer is used, the adhesiveness of the level intended in the present invention is not realized, and use of the oligomer exceeding 30-mer is associated with the difficulty of stable supply. The partial hydrolysis of the hydrolyzable silane may be accomplished by a method commonly used in the art, and the intended component (B) can be obtained by such method. The component (B) may be used at a content of in the range of 0.1 to 50 parts by weight, and preferably 1 to 30 parts by weight in relation to 100 parts by weight of the component (A). Sufficient crosslinking is not achieved and the composition having the rubber elasticity of the intended level will not be produced when used at less than 0.1 part by weight, and use in excess of 50 parts by weight is likely to invite loss of mechanical properties of the cured product.

### Component (C)

The at least one filler of the component (C) is a reinforcing or non-reinforcing filler which is used for the purpose of imparting the composition of the present invention with rubbery physical properties. Exemplary fillers used in the present invention include surface treated or untreated fumed silica, precipitated silica, wet silica, carbon powder, talc, bentonite, surface treated or untreated calcium carbonate, zinc carbonate, magnesium carbonate, surface treated or untreated calcium oxide, zinc oxide, magnesium oxide, aluminum oxide, and aluminum hydroxide. The preferred are surface treated or untreated fumed silica and surface treated or untreated calcium carbonate. The filler of the present invention is used at a content of 1 to 500 parts by weight, and preferably 2 to 400 parts by weight in relation to 100 parts by weight of component (A). When used at less than 1 parts by weight, the intended bond strength is not realized due to the insufficient strength of the rubber, and use in excess of 500 parts by weight results in the increased viscosity of the material, and hence, in the reduced workability.

### Component (D)

The component (D) used in the present invention is the catalyst incorporated for the curing of the composition of the present invention, and examples include organotitanium compounds such as tetraisopropoxy titanium, tetra-t-butoxy titanium, titanium di(isopropoxy)bis(ethylacetoacetate), and titanium di(isopropoxy)bis(acetylacetoacetate); organic tin compounds dibutyltin dilaurate, dibutyltin bisacetylacetoacetate, and tin octylate; metal dicarboxylate such as lead dioctylate; organozirconium compounds such as zirconium tetraacetyl acetonate; organoaluminium compound such as aluminum triacetyl acetonate; and amines such as hydroxylamine and tributylamine. Among these, the preferred is organotitanium compound, and in view of realizing the improved adhesion and storage stability of the present composition, the most preferred are titanate esters and titanium chelate catalysts.

Examples of the component (D) include diisopropoxy bis(ethyl acetoacetate)titanium, dilsopropoxy bis(acetyl acetone)titanium, dibutoxy bis(methyl acetoacetate)titanium, and those represented by the following formulae:

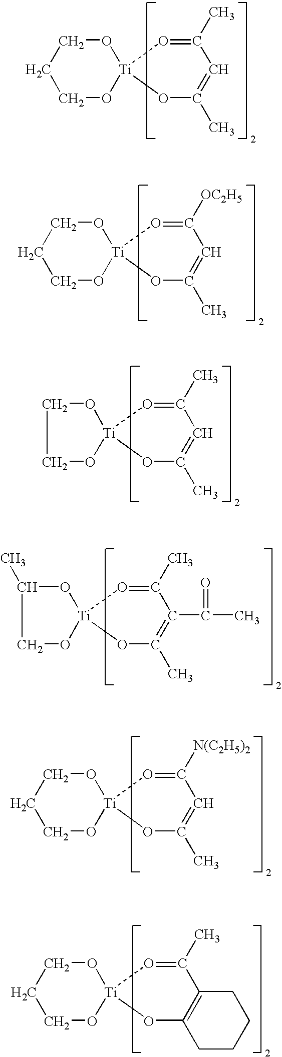

Component (D) may be used at a catalytic amount, and typically, at 0.01 to 10 parts by weight, and preferably at 0.05 to 7 parts by weight in relation to 100 parts by weight of component (A). When component (D) is used at an excessively small amount, the composition of the present invention will have an insufficient curability, while excessive use may invite loss of storage stability.

### Component (E)

The silane coupling agent of component (E) is a component which contributes for adhesion of the composition of the present invention. The silane coupling agent used is preferably the one known in the art, and in particular, the one having an alkoxy silyl group or an alkenoxy silyl group as a hydrolyzable group. Exemplary such silane coupling agents include vinyltris(β-methoxyethoxy)silane,
γ-methacryloxypropyltrimethoxysilane,
β-(3,4-epoxycyclohexyl)ethyltrimethoxysilane,
γ-glycidoxypropyl trimethoxysilane,
γ-glycidoxypropylmethyldiethoxysilane,
N-β-(aminoethyl)y-aminopropyltrimethoxysilane,
γ-aminopropyltriethoxysilane,
γ-mercaptopropyltrimethoxysilane,
γ-glycidoxypropyltriisopropenoxysilane,
γ-glycidoxypropylmethyldiisopropenoxysilane,
a Michael adduct of (meth)acrylsilane and aminosilane,
   a reaction product of epoxysilane and aminosilane. Use of an epoxy or amine silane coupling agent is most preferable.

This silane coupling agent may be used at a content of 0.1 to 10 parts by weight, and preferably at 0.2 to 5 parts by weight in relation to 100 parts by weight of component (A). Sufficient bond strength was not realized when the silane coupling agent was used at less than 0.1 parts by weight, while use in excess of 10 parts by weight may result in economic disadvantage.

### Other Components

The composition may further contain additives commonly known in the art as long as the benefits of the present invention are not adversely affected. Exemplary such additives include plasticizers such as silicone oil and isoparaffin, and optionally added thixotropic agents such as polyether, colorants such as pigments, dyes, and fluorescence brightening agents, heat resistance improver such as iron red and cerium oxide, cold resistance improver, anticorrosive, antimold, and antifungal agent. The composition may also include a solvent such as toluene, xylene, volatile oil, cyclohexane, methylcyclohexane, or low boiling isoparaffin.

The room temperature-curable polyorganosiloxane composition of the present invention cures by reacting with the moisture in air. The composition typically becomes a rubber elastomer when left in the atmosphere at 0 to 50° C. for 0.5 to 7 days.

Accordingly, the polyorganosiloxane composition of the present invention is well adapted for use as a sealant for acrylic resin, polycarbonate, and the like, and for adhesion and securing of electric and electronic parts, for example, protection of electrodes of a flat panel display, securing electrode box of a solar cell, sealing of automobile lamps, and sealing of automobile ECU case, and in particular, for use as an adhesive with resins whose adhesion has been difficult such as polyimide resin, acrylic resin, polycarbonate, polyamide, polybuthylene terephthalate (PBT), and polyphenylene sulfide (PPS).

### EXAMPLES

Next, the present invention is described in further detail by referring to Examples and Comparative Examples, which by no means limit the scope of the present invention.

### Example 1

To a mixture of 20 parts by weight of polydimethylsiloxane endcapped with trimethoxysiloxy group having a viscosity at 23° C. of 20,000 mPa·s and 80 parts by weight of polydimethylsiloxane endcapped with trimethoxysiloxy group having a viscosity at 23° C. of 900 mPa-s were added 2 parts by weight of fumed silica which had been surface treated with dimethyl dichlorosilane having a specific surface area of 130 m²/g, and the mixture was mixed in a blender. To this mixture, 3 parts by weight of a hydrolysate mixture of methyltrimethoxysilane containing tetramer and pentamer as its main components [ratio of dimer/trimer/tetramer/pentamer/hexamer/heptamer/octamer=12/26/22/15/11/8/6 (% by weight)], 1 part by weight of diisopropoxybis(ethyl acetoacetate)titanium, and 1 parts by weight of γ-glycidoxy propyl trimethoxysilane were added, and the mixture was fully mixed under reduced pressure to produce composition 1.

### Example 2

The procedure of Example 1 was repeated except that the methyltrimethoxysilane hydrolysate mixture containing the tetramer and the pentermer as its main component was replaced with a methyltrimethoxysilane hydrolysate mixture containing pentamer, hexamer, and heptamer as its main component [ratio of tetramer/pentamer/hexamer/heptamer/octermer=1/33/31/23/12 (% by weight)] to produce composition 2.

### Example 3

The procedure of Example 1 was repeated except that the methyltrimethoxysilane hydrolysate mixture containing the tetramer and the pentermer as its main components was replaced with a methyltrimethoxysilane hydrolysate mixture containing 20-mer as its main component to produce composition 3.

### Comparative Example 1

The procedure of Example 1 was repeated except that the methyltrimethoxysilane hydrolysate mixture containing the tetramer and the pentermer as its main components was replaced with methyltrimethoxysilane as its main component to produce composition 4.

The silicone rubber composition prepared as described above was cast in a 2 mm flame, and allowed to cure at a temperature of 23° C. and a relative humidity of 50% for 7 days to produce a rubber sheet having a thickness of 2 mm. This rubber sheet was evaluated for its physical properties according to JIS K6249. The results are shown in Table 1. The silicone rubber composition was also coated on a polyimide plate, and after allowing to cure at a temperature of 23° C. and a relative humidity of 50% for 7 days, the coating was peeled off the plate to evaluate the adhesion. The results are also shown in Table 1.

TABLE 1

| | | | | | Comparative |
|---|---|---|---|---|---|
| | | Example 1 | Example 2 | Example 3 | Example 1 |
| Physical | Hardness (Durometer A) | 25 | 28 | 28 | 28 |
| properties | Elongation at break (%) | 120 | 140 | 140 | 130 |
| | Tensile strength (MPa) | 0.6 | 0.7 | 0.7 | 0.6 |
| | Adhesion with polyimide | Not | Not | Not | Peeled |
| | | peeled | peeled | peeled | |

### Example 4

To a mixture of 65 parts by weight of polydimethylsiloxane endcapped with trimethoxysiloxy group having a viscosity at 23° C. of 50,000 mPa·s and 35 parts by weight of polydimethylsiloxane endcapped with trimethylsiloxy group having a viscosity at 23° C. of 100 mPa·s were added 50 parts by weight of colloidal calcium carbonate that has been surface treated with a fatty acid ester, 50 parts by weight of non-surface treated heavy calcium carbonate, and 2 parts by weight of fumed silica surface that had been treated with dimethyl dichlorosilane having a specific surface area of 130 m²/g, and the mixture was mixed in a blender. To this mixture, 3 parts by weight of hydrolysate mixture of methyltrimethoxysilane containing tetramer and pentamer as its main components [ratio of dimer/trimer/tetramer/pentamer/hexamer/heptamer/octermer=12/26/22/15/11/8/6 (% by weight)], 1 parts by weight of diisopropoxybis(ethyl acetoacetate)titanium, and 0.5 parts by weight of reaction product of γ-methacryloxypropyltrimethoxysilane and γ-aminopropyltrimethoxysilane were added, and the mixture was fully mixed under reduced pressure to produce composition 5.

### Example 5

The procedure of Example 4 was repeated except that the 50 parts by weight of the polydimethylsiloxane endcapped with trimethoxysiloxy group was replaced with 50 parts by weight of polydimethylsiloxane endcapped with trimethoxylethylene group having a viscosity at 23° C. of 50,000 mPa·s to produce composition 3.

### Comparative Example 2

The procedure of Example 4 was repeated except that the methyltrimethoxysilane hydrolysate mixture containing the tetramer and the pentermer as its main components was replaced with methyltrimethoxysilane to produce composition 7.

The silicone rubber composition prepared as described above was cast in a 2 mm flame, and allowed to cure at a temperature of 23*C and a relative humidity of 50% for 7 days to produce a rubber sheet having a thickness of 2 mm. This rubber sheet was evaluated for its physical properties according to JIS K6249. The results are shown in Table 2. A test piece for evaluating shear bond strength was prepared by using PBT plates having a width of 25 mm and a length of 100 mm. This test piece had a bonding area of 2.5 mm² and bonding thickness of 2 mm, and the test piece was allowed to cure at a temperature of 23° C. and a relative humidity of 50% for 7 days to confirm its shear bond strength and area percentage of cohesive failure. The results are also shown in Table 2.

TABLE 2

| | | | | Comparative |
|---|---|---|---|---|
| | | Example 4 | Example 5 | Example 2 |
| Physical | Hardness (Durometer | 30 | 31 | 25 |
| properties | A) | | | |
| | Elongation at break | 400 | 420 | 500 |
| | (%) | | | |
| | Tensile strength (MPa) | 2.2 | 2.1 | 2.2 |
| | PBT shear bond | 2.0 | 2.1 | 0.2 |
| | strength (MPa) | | | |
| | Percentage of cohesive | 100 | 100 | 0 |
| | fracture area (%) | | | |

Japanese Patent Application No. 2006-155821 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A room temperature-curable polyorganosiloxane composition comprising
(A) 100 parts by weight of a polyorganosiloxane represented by the following general formula (1): 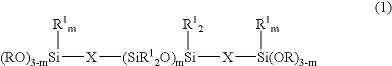
wherein R is a monovalent hydrocarbon group containing 1 to 5 carbon atoms, R¹ is independently a substituted or unsubstituted monovalent hydrocarbon group containing 1 to 10 carbon atoms; n is an integer of at least 10; X is oxygen atom or an alkylene group containing 2 to 5 carbon atoms, and m is independently an integer of 0 or 1; or a mixture of such polyorganosiloxane,
(B) 0.1 to 50 parts by weight of a partial hydrolysate of an organosilicon compound having at least 3 hydrolyzable groups bonded to silicon atom in one molecule;
(C) 1 to 500 parts by weight of at least one filler,
(D) 0.01 to 10 parts by weight of a curing catalyst, and
(E) 0.1 to 10 parts by weight of a silane coupling agent.

2. The room temperature-curable polyorganosiloxane composition according to claim 1 wherein R in the component (A) is methyl group or ethyl group.

3. The room temperature-curable polyorganosiloxane composition according to claim 1 wherein the hydrolyzable group in the component (B) is an alkoxy group.

4. The room temperature-curable polyorganosiloxane composition according to claim 1 wherein the component (B) is a dimer to 30-mer of the corresponding alkoxysilane monomer.

5. The room temperature-curable polyorganosiloxane composition according to claim 1 wherein the component (C) is fumed silica and/or calcium carbonate.

6. The room temperature-curable polyorganosiloxane composition according to claim 1 wherein the component (D) is a titanate ester or a titanium chelate catalyst.

7. The room temperature-curable polyorganosiloxane composition according to claim 1 wherein the composition is used for adhesion of a polyimide resin, an acrylic resin, a polycarbonate, a polyamide, a polybuthylene terephthalate, or a polyphenylene sulfide.
